(19) United States
(12) Patent Application Publication
(10) Pub. No.: US 2009/0061770 A1
(43) Pub. Date: Mar. 5, 2009

(54) BLUETOOTH DEVICE WITH ON-DEMAND PAGE SCAN

(76) Inventor: Kare AGARDH, Rydeback (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/849,422

(22) Filed: Sep. 4, 2007

(51) Int. Cl. H04B 7/00

(52) U.S. Cl. 455/41.2

(57) ABSTRACT

A Bluetooth device that includes a Bluetooth transceiver operatively configured to perform inquiry scans and page scans periodically during a standby mode, and to carry out communications during a connection state. The device further includes a Bluetooth controller for controlling operation of the transceiver, the controller being operatively configured to selectively control the transceiver to perform the inquiry scans and the page scans concurrently in a normal standby mode, and to perform the inquiry scans alone in the absence of the page scans in an on-demand page scanning mode, as a function of a predefined criteria.

### TECHNICAL FIELD OF THE INVENTION

The present invention relates generally to devices that utilize Bluetooth wireless technology, and more particularly to Bluetooth devices with improved reduced power consumption, and methods associated therewith.

### DESCRIPTION OF THE RELATED ART

Bluetooth wireless technology is a short-range communications technology intended to replace the cables connecting portable and/or fixed devices while maintaining high levels of security. The key features of Bluetooth technology are robustness, low power, and low cost. The Bluetooth specification defines a uniform structure for a wide range of devices to connect and communicate with each other.

All Bluetooth devices are in standby mode by default. In standby mode, unconnected devices periodically listen for messages. This procedure is called scanning which is divided into two types: page scan and inquiry scan. Page scan is defined as the connection sub-state in which a device listens for its own device access code (DAC) (via a “page”) for the duration of the scan window (11.25 ms) and is used to set up an actual connection between devices. Inquiry scan is very similar to page scan except that in this sub-state the receiving device scans for the inquiry access code (IAC) (via an “inquiry”). Inquiry scan is used to discover which units are in range and their respective device addresses and clocks.

During the page procedure a device assumes either the role of the master or of the slave. The slave device wakes up every 11.25 ms (i.e. the scan window) to listen for its DAC. The scanning performed by the slave device is done on one frequency hop sequence determined by the hardware within the unit. In a page scan, a device listens for its own device access code for the duration of the scan window. During the scan window, the device listens at a single hop frequency, its correlator matched to its device access code. The scan window is long enough to completely scan 16 page frequencies. It selects the scan frequency according to the page 32-hop hopping sequence corresponding to the unit. Every 1.28 seconds a different frequency is selected.

During a page, the master repeatedly transmits the slave's DAC in an attempt to form a connection between the devices. This transmission occurs during each of the page hops with the page train. If at any point a response is received from the slave unit, the master unit enters the master response substate.

The master (i.e., source) uses the page to activate and connect to a slave (i.e. destination) that periodically wakes up in the page scan substate. The master tries to capture the slave by repeatedly transmitting the slave's device access code (DAC) in different hop channels. In the page state, the master transmits the device access code in an ID packet corresponding to the slave to be connected, rapidly on a large number of different hop frequencies. Since the ID packet is a very short packet, the hop rate can be increased from 1600 hops/s to 3200 hops/s. Since the Bluetooth clocks of the master and the slave are not synchronized, the master does not know exactly when the slave wakes up and on which hop frequency. Therefore, it transmits a train of identical DACs at different hop frequencies, and listens in between the transmit intervals until it receives a response from the slave.

During standby mode, the inquiry scan and page scan consume battery current within the Bluetooth device. This can be undesirable in that considerable battery power is consumed even while the device remains unconnected.

One method for reducing current consumption during standby mode is described in US Application Publication No. 2006/0128308. However, the method described therein places requirements on the radio frequency (RF) receiver to be capable of setting a wide band and short settling time. In a standby mode, the receiver sweeps quickly over a wide band and detects any RF energy. If the detected energy is greater than a threshold, normal Bluetooth page or inquiry scans are then performed within the scan window. A problem with such approach is that the Bluetooth device is susceptible to switching to normal Bluetooth page or inquiry scans based on the detection of other RF traffic in the band, e.g., WLANs, microwaves, etc. The power consumption will in turn increase as a result of the Bluetooth device switching to normal standby mode operation due to unrelated RF traffic.

In view of the aforementioned shortcomings associated with reducing power consumption in Bluetooth devices, there is a strong desire for a Bluetooth device and method that further reduces power consumption thereby increasing battery life, etc.

### SUMMARY

According to an aspect of the invention, a Bluetooth device is provided that includes a Bluetooth transceiver operatively configured to perform inquiry scans and page scans periodically during a standby mode, and to carry out communications during a connection state. The device further includes a Bluetooth controller for controlling operation of the transceiver, the controller being operatively configured to selectively control the transceiver to perform the inquiry scans and the page scans concurrently in a normal standby mode, and to perform the inquiry scans alone in the absence of the page scans in an on-demand page scanning mode, as a function of a predefined criteria.

In accordance with a particular aspect, the predefined criteria is a default setting of the device, whereby the device defaults to the on-demand page scanning mode.

According to another aspect, the predefined criteria is selection of a low power consumption mode of the device.

According to still another aspect, the predefined criteria is the expiration of a predefined time period during the normal standby mode in which a page is not received by the device, the expiration of the predefined time period resulting in the device transitioning from the normal standby mode to the on-demand page scanning mode.

In yet another aspect, the on-demand page scanning mode the device listens for an inquiry from a remote device during the inquiry scans and, upon receipt of such an inquiry, the device transitions to the normal standby mode.

In still another aspect, the device further includes a host application for performing a user controlled operation involving communications with a remote device via the transceiver.

According to another aspect, the host application comprises a mobile phone application.

In yet another aspect, the remote device is a Bluetooth headset.

In accordance with another aspect, the predefined criteria is a default setting of the device, whereby the device defaults to the on-demand page scanning mode, and wherein in the on-demand page scanning mode the device listens for an inquiry from the headset during the inquiry scans and, upon receipt of such an inquiry, the device transitions to the normal standby mode.

According to another aspect, a method for performing Bluetooth connectivity in a Bluetooth device is provided. The method includes performing inquiry scans and page scans concurrently in a normal standby mode, or inquiry scans alone in the absence of the page scans in an on-demand page scanning mode, selectively as a function of a predefined criteria.

In accordance with still another aspect, the predefined criteria is a default setting of the device, whereby the device defaults to the on-demand page scanning mode.

According to still another aspect, the predefined criteria is selection of a low power consumption mode of the device.

In still another aspect, the predefined criteria is the expiration of a predefined time period during the normal standby mode in which a page is not received by the device, the expiration of the predefined time period resulting in the device transitioning from the normal standby mode to the on-demand page scanning mode.

According to another aspect, the on-demand page scanning mode the device listens for an inquiry from a remote device during the inquiry scans and, upon receipt of such an inquiry, the device transitions to the normal standby mode.

In another aspect, the device is a mobile phone.

In still another aspect, the remote device is a Bluetooth headset.

According to another aspect, the predefined criteria is a default setting of the mobile phone, whereby the mobile phone defaults to the on-demand page scanning mode, and wherein in the on-demand page scanning mode the mobile phone listens for an inquiry from the headset during the inquiry scans and, upon receipt of such an inquiry, the mobile phone transitions to the normal standby mode.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a block diagram of a Bluetooth device in accordance with an exemplary embodiment of the present invention;

FIG. 2 is a timing diagram illustrating normal standby operation in accordance with an embodiment of the present invention;

FIG. 3 is a timing diagram illustrating on-demand page scanning operation in accordance with an embodiment of the present invention;

FIG. 4 is a timing diagram illustrating a transition between normal standby operation and on-demand page scanning operation in accordance with the present invention; and

FIG. 5 is a flowchart illustrating standby mode operation in accordance with the present invention.

### DETAILED DESCRIPTION OF EMBODIMENTS

The present invention will now be described with reference to the drawings, in which like reference numerals are used to refer to like elements throughout.

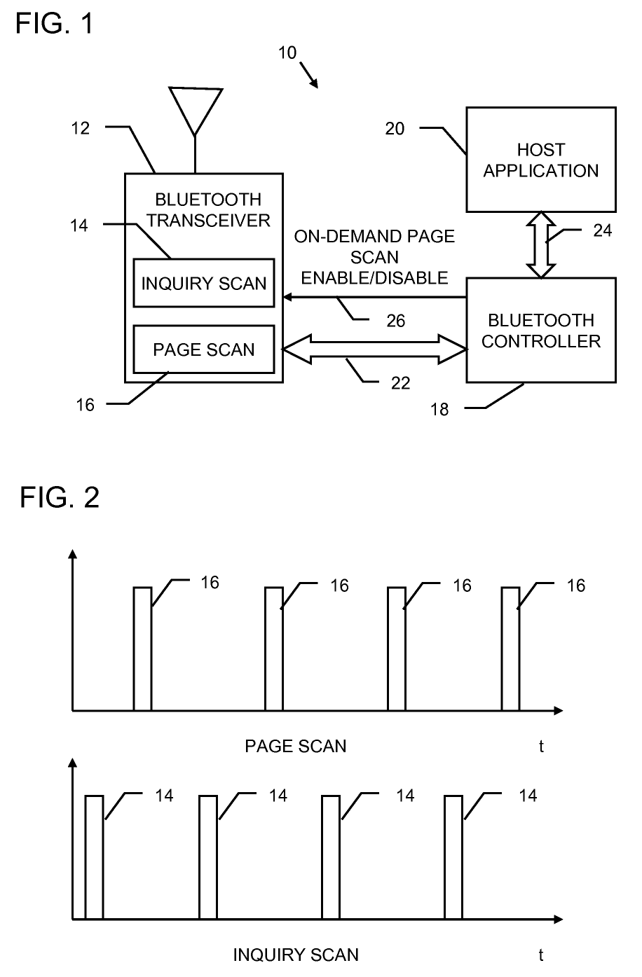

Referring initially to FIG. 1, a Bluetooth device 10 is shown in accordance with an exemplary embodiment of the present invention. The device 10 includes a Bluetooth transceiver 12 operative to perform inquiry scans 14 and page scans 16 periodically during a standby mode, and to carry out communications during a connection state. Using known techniques, the Bluetooth device 10 in a standby mode carries out inquiry scans 14 via the transceiver 12 to listen for inquiries, namely an inquiry access code (IAC) from any remote devices seeking to connect with the Bluetooth device 12. The Bluetooth device 10 carries out page scans 16 via the transceiver 12 to listen for pages, namely its own device access code (DAC) from a remote device seeking to connect specifically to the Bluetooth device 10.

The Bluetooth device 10 includes a Bluetooth controller 18 for controlling operation of the transceiver 12. Although shown as a discrete element in FIG. 1, the controller 18 may be viewed as incorporated within the transceiver 12 itself. As will be explained in more detail below, the controller 18 is operatively configured to selectively control the transceiver 12 to perform the inquiry scans 14 and the page scans 16 concurrently in a normal operation mode, and to perform the inquiry scans 14 alone in the absence of the page scans 16 in an on-demand page scanning mode. The controller 18 performs such control as a function of a predefined criteria. Such predefined criteria may be based on default settings of the device 10, a time-out feature, etc., as will be appreciated based on the description herein.

In the exemplary embodiment, the device 10 further includes a host application 20. The host application 20 may be any application for which a Bluetooth connection is desirable. For example, in the exemplary embodiment the host application 20 is that of a mobile device such as a mobile phone. A mobile phone allows a user to conduct mobile communications, exchange data, surf the internet, take photographs, etc. In many situations, it is desirable that the mobile phone be capable of connecting with one or more remote devices via the Bluetooth connection. As one example, the mobile phone may wish to connect to a Bluetooth headset to permit hands-free operation. Those having ordinary skill in the art will appreciate that the particular type of host application 20 is not germane to the present invention in its broadest sense. The host application 20 can be representative of any type Bluetooth device. Similarly, the remote device or devices can be any type of Bluetooth device and are not limited to headsets, etc.

The controller 18 communicates with the transceiver 12 conventionally via a control/data bus 22. Similarly, the controller 18 communicates conventionally with the host application 20 via a control/data bus 24. Consequently, the host application 20 together with the Bluetooth transceiver 12 and controller 18 enables the Bluetooth device 10 to communicate with one or more remote devices according to conventional Bluetooth operation.

According to the exemplary embodiment of the present invention, the controller 18 also provides on-demand page scan control to the transceiver 12. Using on-demand page scan control, the present invention is able to reduce significantly power consumption of the Bluetooth device 10. As described more fully below, on-demand page scanning, when enabled, results in the device 10 performing only inquiry scans 14 and not page scans 16 during standby mode. By foregoing the page scans 16, the device 10 consumes less power in standby mode. In the event the device 10 receives an inquiry from a remote device during an inquiry scan 14, the device 10 “wakes up” and activates conventional page scanning. The standby operation of the device 10 thus returns to normal. The device 10 responds to the inquiry by transmitting an inquiry response including the DAC of the device 10 as is conventional. The device 10, with conventional page scanning activated, can then listen for and respond to a subsequent page from the remote device and establish the Bluetooth connection.

According to the exemplary embodiment, the controller 18 enables and disables on-demand page scanning within the transceiver 12 via a control line 26. When the control signal on line 26 is active, on-demand page scanning is active. As a result, page scans 16 by the transceiver 12 are disabled during standby mode while inquiry scans 14 are carried out. When the control signal on line 26 is inactive, on-demand page scanning is inactive during standby mode and the transceiver 12 carries out both inquiry scans 14 and page scans 16.

The controller 18 may control when on-demand page scanning is active based on any of a variety of predefined criteria. For example, the controller 18 may be configured such that the default setting of the device 10 is for on-demand page scanning to be enabled. As a particular example, a user may purchase a Bluetooth device 10 in the form of a mobile phone. Upon powering up of the phone for the first time (i.e., “out-of-the-box”), the default setting of the device 10 will be for transceiver 12 to be in the standby mode with on-demand page scanning enabled. In the event a nearby remote device, such as a headset, transmits an inquiry, the mobile phone device 10 will respond to the inquiry and enable page scanning so that a page may be received and the connection between the mobile phone device 10 and the remote device may be completed.

By having the default state of the device 10 (e.g., mobile phone) set such that the transceiver 12 is in the standby mode and on-demand page scanning is enabled, the device 10 will be configured to receive inquiries from nearby remote devices (e.g., headset) upon initial power up (i.e., right “out-of-the-box”). There is no need for the user to navigate through various menus on the device 10 in order to locate the appropriate menu to activate the Bluetooth transceiver 12 and thereby enable Bluetooth connectivity. The device 10 will begin performing inquiry scans upon initial power up. Since on-demand page scanning is enabled by default, the device 10 will not consume as much power as in the case of normal standby mode when both page scanning and inquiry scanning are performed. This makes it more suitable for the device 10 to have a default setting of standby mode operation with on-demand page scanning enabled.

Should the device 10 receive an inquiry while in the default setting of on-demand page scanning, page scanning is enabled as discussed above. The device 10, in turn, may be configured to display a simple query to the user such as “Do you wish to Connect to Headset ABC (Yes/No)”. In this manner, the user is queried whether he/she wishes to connect to a remote device (such as Headset ABC) without incurring the complexity of first having to understand and navigate through various menus, etc. in order to activate the transceiver 12. Therefore, the default mode “out-of-the-box” may be that the transceiver 12 is active in the standby mode, but relatively high power consumption is avoided by virtue of page scanning being disabled. Of course, the user may subsequently change the setting from the default setting as the user becomes more familiar with the device 10 and its operation.

During on-demand page scanning, the device 10 will not be able to receive directly a page from a remote device. If the device 10 has previously been registered or paired with a remote Bluetooth device, the device 10 will not be able to receive and respond directly to a page from the remote device. The remote device will need to establish the connection by first transmitting an inquiry so as to elicit an inquiry response and enable page scanning within the device 10.

Consequently, on-demand page scanning of the present invention is particularly desirable under circumstances where the device 10 is not likely to have already been registered or paired with any surrounding remote devices. As previously explained, the present invention can be particularly useful as a default setting for the device 10 directly “out-of-the-box”. Under such circumstances, it is unlikely that the device 10 has been previously registered or paired with any nearby remote devices. The invention will facilitate Bluetooth connectivity with any remote devices so as not to require that the user be sufficiently knowledgeable/familiar with the device 10 to know how to activate the Bluetooth transceiver 12 and enable the connection. At the same time, the transceiver 12 will not consume as much power in the standby state, making a default setting of on-demand page scanning more practicable in terms of battery consumption.

Other criteria may be utilized for determining if and when on-demand page scanning is enabled within the device 10. For example, the controller 18 may enable on-demand page scanning based on the device 10 entering a low power consumption mode. The user may manually enter the device 10 into a low power consumption mode via a keypad, menu screen, etc. Alternatively, the device 10 may enter into a low power consumption mode automatically, e.g., after a predefined period of inactivity in the device 10. Different levels of low power consumption may be defined, some of which may include on-demand page scanning and others that do not.

As a particular example, the predefined criteria may be the expiration of a predefined time period during the normal standby mode in which a page is not received by the device 10. The transceiver 12 communicates with the controller 18 via the bus 22 with regard to any inquiries or pages that are received. In the event the controller 18 detects the occurrence of the predefined time period, the controller 18 provides a control signal on line 26 which transitions the device 10 from the normal standby mode to the on-demand page scanning mode.

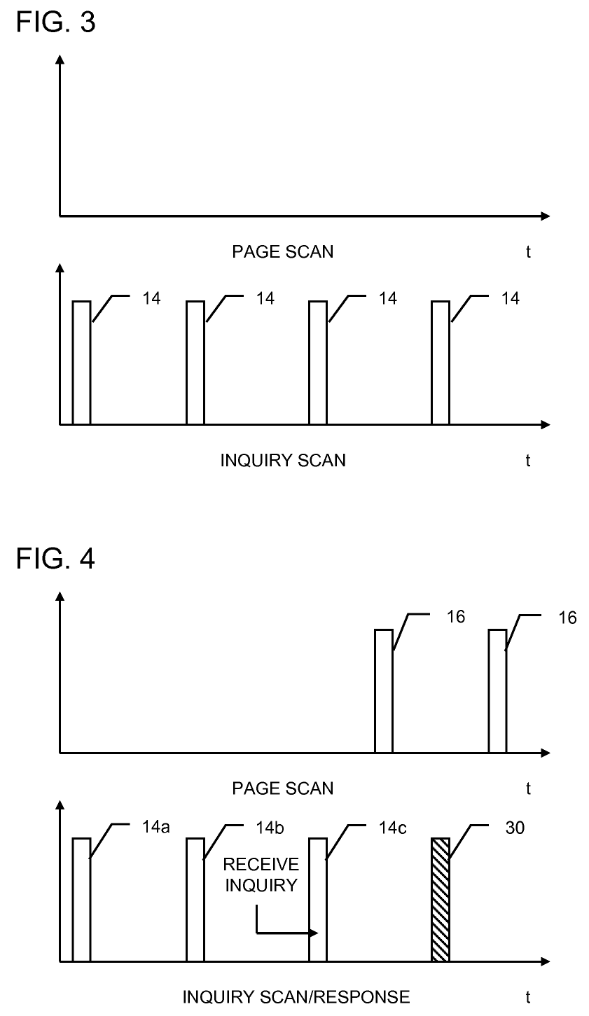

FIG. 2 represents operation of the device 10 during normal standby mode. Specifically, the control signal provided by the controller 18 on line 26 is inactive and the transceiver 12 performs both inquiry scans 14 and page scans 16 periodically as is conventional. Conversely, FIG. 3 illustrates operation of the device during on-demand page scanning mode. Specifically, the control signal provided on line 26 by the controller 18 is active. As a result, the transceiver 12 only performs inquiry scans 14, in the absence of page scans 16.

FIG. 4 illustrates the sequence of events that occurs should the device 10 (e.g., mobile phone) receive an inquiry while in the on-demand page scanning mode. Initially, the control signal provided by the controller 18 on line 26 is active. Thus, the transceiver 12 performs only inquiry scans as represented, for example, by inquiry scans 14a and 14b. Suppose the transceiver 12 then receives an inquiry from a remote device (e.g., headset) during on-demand scanning, e.g., during inquiry scan 14c. The transceiver 12 communicates such occurrence to the controller 18. The controller 18 in turn renders the control signal on line 26 inactive such that the transceiver 12 begins to perform page scans 16 together with the inquiry scans 14 in a normal standby mode as is conventional. The device 10 also proceeds to attempt to establish a connection with the remote device as is conventional. For example, the transceiver 12 transmits a response 30 to the inquiry. During a subsequent page scan 16, the transceiver 12 will in turn receive a page from the remote device so as to enable the devices to connect with one another. Should a connection not be made for whatever reason, the device 10 may be configured to return automatically back to the on-demand page scanning mode.

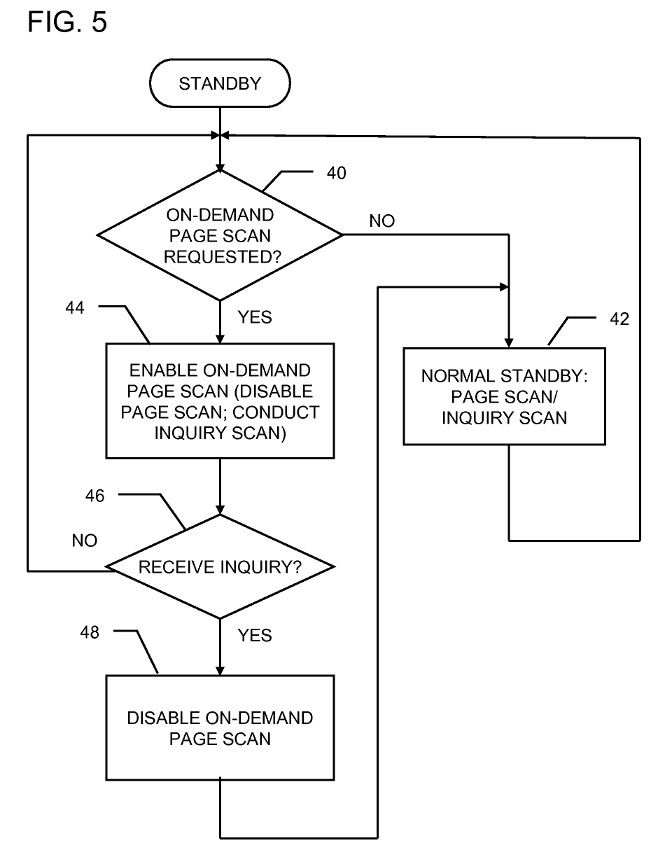

FIG. 5 is an exemplary flowchart suitable for programming a device 10 to operate in standby mode in accordance with the present invention. Those having ordinary skill in the art of programming Bluetooth devices and controllers will readily understand how to program the device 10 to carry such operations with undue effort. Consequently, additional detail regarding specific programming code has been omitted for sake of brevity.

During standby mode, the device 10 determines if on-demand page scanning has been requested as represented in step 40. As previously discussed, on-demand page scanning may be set as the default mode for the device 10. Alternatively, on-demand page scanning may have been requested as a result of the device 10 not having received a page within a predefined time period. Still further, on-demand page scanning may have been requested by user selection on a menu or the like. The particular manner in which on-demand page scanning is requested is not germane to the invention in its broadest sense.

If on-demand page scanning has not been requested as determined in step 40, the control signal on line 26 is inactive. As a result, the transceiver 12 performs normal standby mode operation as represented in step 42 (and FIG. 2). The device 10 then loops through steps 40 and 42.

In the event on-demand page scanning has been requested as determined in step 40, the device 10 proceeds to step 44 in which the controller 18 provides an active control signal on line 26. On-demand page scanning is thus enabled, and operation then proceeds as described above (e.g., as shown in FIG. 3). Next, in step 46 the device 10 determines if an inquiry has been received from a remote device (such as during inquiry scan 14c of FIG. 4). If yes, the device 10 disables the on-demand page scanning as represented by step 48. Specifically, the control signal on line 26 is made inactive and the device 10 proceeds to step 42 and operation in the normal standby mode. Specifically, the transceiver 12 begins to perform both inquiry scans 14 and page scans 16 as is conventional. The device returns to step 40 and normal standby mode operation is continued unless and until on-demand page scanning is again requested.

If an inquiry has not been received as determined in step 46, the device 10 returns to step 40 and continues on-demand page scanning mode until an inquiry is received (step 46) or on-demand page scanning is no longer requested (step 40). If during normal standby mode, an inquiry or page is received by the device 10, the device 10 then proceeds from standby mode to according to conventional Bluetooth connection protocol as will be appreciated.

Accordingly, the device and method of the present invention makes it possible to significantly reduce power consumption of a Bluetooth device by reducing power consumption during the standby mode.

The term “Bluetooth device” as referred to herein includes portable radio communication equipment. The term “portable radio communication equipment”, also referred to herein as a “mobile device”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. For example, the present invention may be combined with other techniques for reducing power consumption of the Bluetooth device (e.g., adjusting the time intervals of the inquiry scans and/or page scans). The present invention includes all such equivalents and modifications, and is limited only by the scope of the following claims.

1. A Bluetooth device, comprising:
a Bluetooth transceiver operatively configured to perform inquiry scans and page scans periodically during a standby mode, and to carry out communications during a connection state;
a Bluetooth controller for controlling operation of the transceiver, the controller being operatively configured to selectively control the transceiver to perform the inquiry scans and the page scans concurrently in a normal standby mode, and to perform the inquiry scans alone in the absence of the page scans in an on-demand page scanning mode, as a function of a predefined criteria.

2. The device of claim 1, wherein the predefined criteria is a default setting of the device, whereby the device defaults to the on-demand page scanning mode.

3. The device of claim 1, wherein the predefined criteria is selection of a low power consumption mode of the device.

4. The device of claim 1, wherein the predefined criteria is expiration of a predefined time period during the normal standby mode in which a page is not received by the device, the expiration of the predefined time period resulting in the device transitioning from the normal standby mode to the on-demand page scanning mode.

5. The device of claim 1, wherein in the on-demand page scanning mode the device listens for an inquiry from a remote device during the inquiry scans and, upon receipt of such an inquiry, the device transitions to the normal standby mode.

6. The device of claim 1, further comprising a host application for performing a user controlled operation involving communications with a remote device via the transceiver.

7. The device of claim 6, wherein the host application comprises a mobile phone application.

8. The device of claim 7, wherein the remote device is a Bluetooth headset.

9. The device of claim 8, wherein the predefined criteria is a default setting of the device, whereby the device defaults to the on-demand page scanning mode, and
wherein in the on-demand page scanning mode the device listens for an inquiry from the headset during the inquiry scans and, upon receipt of such an inquiry, the device transitions to the normal standby mode.

10. A method for performing Bluetooth connectivity in a Bluetooth device, comprising:
performing inquiry scans and page scans concurrently in a normal standby mode, or inquiry scans alone in the absence of the page scans in an on-demand page scanning mode, selectively as a function of a predefined criteria.

11. The method of claim 10, wherein the predefined criteria is a default setting of the device, whereby the device defaults to the on-demand page scanning mode.

12. The method of claim 10, wherein the predefined criteria is selection of a low power consumption mode of the device.

13. The method of claim 10, wherein the predefined criteria is expiration of a predefined time period during the normal standby mode in which a page is not received by the device, the expiration of the predefined time period resulting in the device transitioning from the normal standby mode to the on-demand page scanning mode.

14. The method of claim 10, wherein in the on-demand page scanning mode the device listens for an inquiry from a remote device during the inquiry scans and, upon receipt of such an inquiry, the device transitions to the normal standby mode.

15. The method of claim 14, wherein the device is a mobile phone.

16. The method of claim 15, wherein the remote device is a Bluetooth headset.

17. The device of claim 16, wherein the predefined criteria is a default setting of the mobile phone, whereby the mobile phone defaults to the on-demand page scanning mode, and
wherein in the on-demand page scanning mode the mobile phone listens for an inquiry from the headset during the inquiry scans and, upon receipt of such an inquiry, the mobile phone transitions to the normal standby mode.
